(19) United States
(12) Patent Application Publication
(10) Pub. No.: US 2020/0180083 A1
(43) Pub. Date: Jun. 11, 2020

(54) METHOD FOR IMPROVED MANUFACTURING OF A DUAL MICROSTRUCTURE PART

(71) Applicant: SAFRAN, Paris (FR)

(72) Inventor: Sebastien Jean RICHARD, Moissy-Cramayel (FR)

(21) Appl. No.: 16/617,771

(22) PCT Filed: Jun. 1, 2018
(86) PCT No.: PCT/EP2018/064535

§ 371 Date: Nov. 27, 2019

(30) Foreign Application Priority Data
Jun. 1, 2017 (FR) 1754877
Apr. 18, 2018 (FR) 1853418

(51) Int. Cl. B23K 35/30; B23K 35/02; B22F 7/06

(52) U.S. Cl. CPC B23K 35/302; B22F 7/064; B23K 35/0244

(57) ABSTRACT

A method for welding together at least two parts of green material, referred to as green parts, by means of co-sintering, comprising the following steps:—assembling the at least two green parts at a junction zone of said parts so as to form a green one-piece assembly,—de-binding the green one-piece assembly, and—sintering the one-piece assembly so as to obtain a dense one-piece assembly forming a final part, characterised in that the two green parts (10, 12) each have a composition of different powder, so as to produce a final part (1) having at least two parts with different grain sizes.

### TECHNICAL FIELD

The present invention relates to the field of the production of metal or ceramic parts by a method of “forming then de-binding”, for example a PIM (Powder Injection Moulding) method, and in particular, a method of welding by co-sintering.

### PRIOR ART

In a conventional manner known per se, the production of parts by a method of the “forming then de-binding” type, in particular a PIM method, comprises four steps:
providing a feedstock, or “green” material,
forming (obtaining a “green” part),
de-binding, and
sintering (obtaining a dense part).

The forming can for example be obtained by 3D printing or, in the specific case of the PIM method, by moulding. The step of providing the feedstock (green material) consists mainly of mixing a powder of one or more metal and/or ceramic materials that form the part to be manufactured with one (or more) thermoplastic binders with a polymer base. This step is generally carried out using mixers and/or extruders under a high rate of shearing in order to ensure good homogeneity of the mixture. A relatively substantial quantity of powder must be incorporated in the binder or binders in order to ensure the cohesion of the future part. If the mixture comprises too much powder, this results in a viscosity that is too high, which renders the step of moulding difficult and favours the appearance of cracks. If, on the contrary, the mixture comprises too much binder, the risk of the part to be manufactured collapsing during the step of de-binding increases.

In the case of a PIM method, the step of moulding consists of placing the feedstock (conventionally in the form of granules) in an injection press similar to that in the plastics industry. In the case of other methods of the “forming then de-binding” type, this can in particular be a 3D printing. A part referred to as a green part is then obtained which is already substantially of the shape desired for the dense part (final).

The step of de-binding consists of removing the thermoplastic binder or binders via a method adapted to the type or types. If this step is poorly controlled, it can be the source of damage to the part during manufacture via the appearance of defects, for example cracks or chemical contamination. At the end of the step of de-binding, the part is porous.

The sintering step consists of consolidating and in densifying the de-bound green part in order to obtain the final part. The part is thus heated, and this consolidation and densification are accompanied by a shrinkage in volume which depends on the initial composition of the feedstock. This step is carried out at a high temperature, but however such that the material of the de-bound green part is not entirely melted: under the effect of the heat, the grains of material are welded together. A distinction is made between solid-phase sintering (all of the material of the part is in solid form), and sintering in liquid phase (a portion of the material of the part has reached its melting point). At the end of the sintering step, a dense part is obtained, the final part.

Moreover and independently, the aeronautics industry has made, in the last few years, much progress making it possible to increase the temperature capability of the materials that form the parts of engines of aircraft or turbines of helicopters, for example. However the gains in temperature obtained remain limited and it is starting to be admitted that a chemical composition and a microstructure of a given material cannot, alone, make it possible to fulfil the objectives set by the specifications and the technical needs.

This is because the performance of a part (formed from a given material) resides in its capacity to achieve, for an optimised homogeneous microstructure, the best compromise between the various mechanical properties required. These properties are moreover often contradictory.

A means of pushing back the limits of current materials is to adapt the microstructure of the engine part to the local stresses of the environment of said part on the latter.

This amounts to producing, on the same part, a dual microstructure (with a chemical composition or grain size that is different from one portion of the part to another) or a microstructure with a gradient (with a grain size or chemical composition that varies progressively along the part). For example, for a turbine disc, which is one of the most thermomechanically stressed parts in a turbine engine, it is necessary to have a so-called “fine grain” structure as a disc bore for its traction and fatigue characteristics at a moderate temperature and a so-called “large grain” structure in the rim of the same disc in order to have the best creep and cracking properties at high temperature.

Currently, the best known method for producing a part with a gradient (or dual) structure is a heat treatment, such as shown in document EP 3037194 A1, for example. This heat treatment can, however, be lacking in precision as to the exact locations of the zones of the part the microstructure of which it is necessary to modify compared with those where the microstructure must not be modified. Moreover, in the event of error, the entire part is to be scrapped, which can generate losses at high prices.

Moreover, the techniques of overmoulding (in order to create a final part with a dual microstructure) used in PIM are very limited because the pressures called into play during the injection step are such that it is practically impossible to not break the green part that is to be overmoulded. More generally, it is difficult, regardless of the “forming then de-binding” method considered, to assemble structural sub-assemblies of a large size once the various parts of the structural sub-assembly considered are finalised.

One of the advantages of the PIM method (or of any other method of the “forming then de-binding” type) is the possibility of co-sintering different parts, i.e. assembling them upstream of the sintering step and thus to achieve, in parallel with the sintering, the welding of the different parts together. This makes it possible, for example, to manufacture parts where the geometry would be too complex for a direct forming: it is thus possible to break down these excessively complex parts into sub-assemblies of unit parts that are easy to form, which are then welded together during the sintering step. The various green parts are assembled directly in the green state before the sintering step.

Thus the technical problem that the present invention aims to overcome is to produce engine parts that respond to the needs of adapting their microstructures locally by means of a method of the “forming then de-binding” type, in particular the PIM method.

### DISCLOSURE OF THE INVENTION

The invention proposes for this purpose a method of welding at least two parts of green material, referred to as green parts, comprising the following steps:

assembling the at least two green parts at a junction zone of said parts so as to form a green one-piece assembly,

de-binding the green one-piece assembly, and
sintering the one-piece assembly so as to obtain a dense one-piece assembly forming a final part,

characterised in that the two green parts are each having a different powder composition in such a way as to give a final part comprising at least two parts with a different grain size. This method thus makes it possible to take advantage of the use of the co-sintering of two green parts formed from feedstocks with the same proportion of filler, containing powders with different granulometries or chemistries, making it possible after co-sintering to obtain a single part with a dual microstructure.

It is stated here that the term “granulometry” here is used to designate the size of the particles of powder that are in the feedstock and “grain size” to designate a characteristic element of a microstructure. These two quantities do not, a priori, have any link between them.

Another advantage of the method claimed is that monitoring the soundness of the assembly resulting from the different parts to be welded together can be carried out upstream of the step of de-binding (and therefore of sintering). Thus, in the event of scrapping, the loss generated is less substantial, since the assembly step is a step after which the added value of the part in production is low, contrary to a green part that is already de-bound or even already sintered. A defect detected after de-binding or sintering leads to discarding a part with high added value, which is detrimental economically.

The welding method according to the invention can comprise one or more of the characteristics or steps hereinbelow, taken in isolation from one another or in combination with one another:

the at least two green parts have powder compositions with different granulometries,

the at least two green parts comprise powders that have a D₉₀ less than 16 μm, 25 μm or 45 μm,

the at least two green parts have different powder chemical compositions.

The welding method according to the invention can also include the succession of the following steps:

putting into contact the at least two green parts at a junction zone of these parts,

adding of a weld bead to the green parts in such a way that the weld bead hugs the shape of the junction zone, and in such a way as to form a homogeneous green one-piece assembly,

de-binding the green one-piece assembly, and

sintering of the single-piece assembly in such a way as to obtain a dense and homogeneous one-piece assembly that forms the final part.

This alternative of the method has several advantages in relation to the prior art, in particular the fact that the surface of the junction zone is no longer a limiting character or a possible source of fragility. This is because adding a weld bead makes it possible to extend the surface of the weld (junction zone) if necessary. The surfaces for putting in contact no longer, moreover, need to be prepared upstream, by machining for example: they do not need to cooperate perfectly because the weld bead overcomes any putting-into-contact defects.

The welding method according to the invention can comprise one or more of the characteristics or steps hereinbelow, taken in isolation from one another or in combination with one another:

a step of machining precedes the step of de-binding, in such a way as to rework the weld bead,

the weld bead is of a composition similar to that of the green parts,

the green parts to be assembled are of identical compositions,

the weld bead and the green parts are of identical compositions,

the adding of the weld bead is carried out by means of an injection screw, one nozzle of which points to the junction zone in such a way as to deposit a weld bead made of softened green material,

the adding of the weld bead is carried out by positioning a strip of solid green material in contact with the junction zone, and by heating this strip by means of a hot-air gun,

the adding of the weld bead is automated.

The invention also relates to a dense one-piece assembly forming the final part, comprising at least two parts assembled by the method described hereinabove, characterised in that the two green parts have a different powder composition, in such a way that the final part has at least two portions with a different grain size.

The final part according to the invention can also include green parts that have a different powder chemical composition or a powder composition with different granulometries.

The sintered part can then follow a standard and homogenous heat treatment that is simple to implement because the dual microstructure is already generated.

### DESCRIPTION OF THE FIGURES

The invention will be better understood, and other details, characteristics and advantages of the invention will appear more clearly when reading the following description given by way of a non-limiting example and with reference to the accompanying drawings, wherein:

FIG. 1 is a perspective view of a part that has two portions the microstructure of which has to be differentiated,

FIG. 2 is a perspective view of the step of adding a weld bead between two parts to be welded according to a first alternative of the method claimed,

FIG. 3 is a perspective view of the step of adding a weld bead between two parts to be welded according to a second alternative of the method claimed,

FIG. 4 is a diagrammatic cross-section view of a homogeneous green one-piece assembly according to one or the other of the alternatives of FIGS. 2 and 3,

FIG. 5 is a diagrammatic cross-section view of a homogeneous green one-piece assembly after a step of machining according to one or the other of the alternatives shown hereinabove,

FIG. 6 is a diagrammatic cross-section view of a final part obtained by a conventional prior art method of co-sintering,

FIG. 7 is a diagrammatic cross-section view of a final part obtained by one or the other of the alternatives of the method claimed,

FIG. 8 is a perspective view of the part of FIG. 1 the differentiated microstructure of which has been shown diagrammatically, artificially enlarged.

### DETAILED DESCRIPTION

In this application, the term “feedstock” or “green material” means a mixture according to:

at least one metal and/or ceramic material forming a part to be manufactured, and

one (or more) thermoplastic binders with a polymer base.

This mixture conventionally has the form of granules.

Moreover, in this application, the term “green part” means a part in the process of manufacture that has already been formed but that has not yet been de-bound. This green part therefore has the general shape of the final dense part but, as it has not yet undergone the sintering step, it does not yet have its final dimensions. The sintering step involves a phenomenon referred to as volume shrinkage, which is a phenomenon of dimensional contraction that entails a decrease in the dimensions of the part. This volume shrinkage depends on the initial composition of the feedstock and in particular the proportion of filler in said feedstock. In a formulation, a filler is a solid non-miscible substance dispersed in a matrix via a mechanical means. Thus the proportion of filler corresponds to the volume of powder in the feedstock.

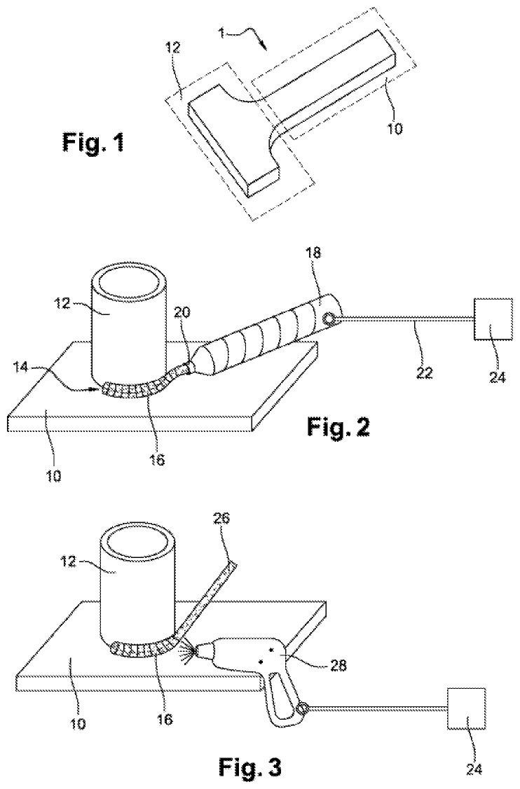

As can be seen in FIG. 1, a user wishes to produce a final part 1 that comprises two parts (or parts 10, 12) with different microstructures.

For example, the user wishes to have a final part 1 that has small grains on the surface (in order to delay a crack initiation under fatigue for example), and in the rest of the part larger grains (in order to have resistance against creep for example).

The production technique according to the method presented here consists of forming the first green part 10 using a feedstock comprising a coarse powder granulometry, and the second green part 12 using a feedstock comprising a finer granulometry (see FIG. 8). The two parts 10, 12 are produced by means of a PIM method (or any other method for forming green parts of the 3D printing type for example) stopping at the step of moulding (or of forming) presented hereinabove.

The two green parts 10, 12 are therefore assembled at a junction zone 14 of these green parts 10, 12 in such a way as to form a green one-piece assembly. This assembly in the green state can in particular be done by the adding of a weld bead made of green material, as explained in detail hereinbelow:

As can be seen in FIGS. 2 and 3, a user wishes to weld two parts: for example, a plate 10 and a hollow cylinder 12. The two parts 10, 12 are so called “green” parts, i.e., as mentioned hereinabove, they have not yet passed the step of de-binding.

The two green parts 10, 12 are therefore put into contact at a junction zone 14 of these green parts 10, 12. A weld bead 16 itself in feedstock is added to the green parts 10, 12 in such a way that the weld bead 16 hugs the shape of the junction zone 14. The assembly then forms a homogeneous green one-piece assembly.

According to the embodiment shown in FIG. 2, the deposition of the weld bead 16 is done using an injection screw 18 a nozzle 20 of which points to the junction zone 14. The temperature at the outlet of the nozzle 20 is substantially the same as the injection temperature during the step of moulding of the green parts 10, 12. For example, for a feedstock Inconel 718® used today by the applicant, the temperature of the nozzle 20 is 190° C. For better control of the method, the injection screw 18 can be mounted on a robot arm 22, connected to a control unit 24 that allows for automation of the method.

According to the embodiment shown in FIG. 3, the adding of the weld bead 16 is carried out in two steps:

firstly, a strip of solid green material 26 is put into contact with the junction zone 14,

secondly, said strip of solid green material 26 is heated by means of a hot-air gun 28 in such a way as to soften the material of the strip 26 and to form the weld bead 16.

As for the preceding embodiment, the hot-air gun 28 can be fixed on a robot arm 24 connected to a control unit 24. This allows, as mentioned hereinabove, for a better control of the step of adding the weld bead 16.

For a green material of formulation Inconel 718® the temperature of the air at the outlet of the gun 28 must be greater than 100° C.

The two green parts 10, 12 can have identical compositions or, as explained hereinafter, different compositions. As with the weld bead 16: the latter can be of a composition similar to that of the two parts 10, 12 to be assembled or of a composition identical thereto (subject to the two parts 10, 12 themselves being of identical composition).

By similar composition is meant a composition that has:

the same proportion of filler as the composition of the other components 10, 12, 16 of the homogeneous green one-piece assembly in order to provide an identical (or substantially identical) volumetric shrinkage of each one of these components 10, 12, 16 during the sintering step,

an identical (or substantially identical) densification speed to that of the other components 10, 12, 16 of the homogeneous green one-piece assembly,

a sintering range compatible with that of the other components 10, 12, 16 of the homogeneous green one-piece assembly.

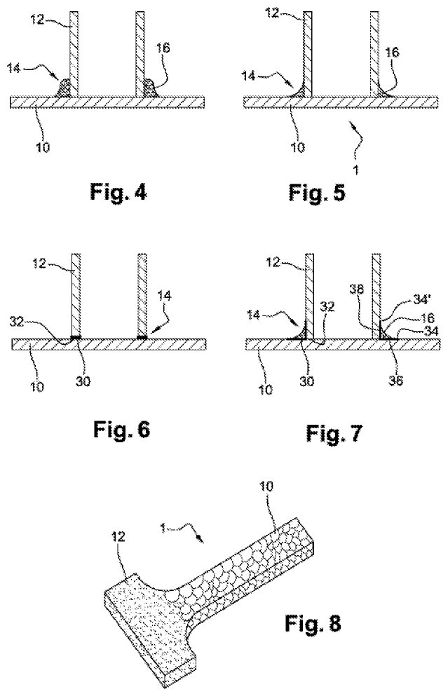

Following the adding of the weld bead 16, the method can comprise a machining step: the weld bead 16 being in the green state, it can be reworked immediately by machining, even before the de-binding step, in order to confer upon it directly a radius or a specific shape, as shown in FIGS. 4 and 5.

The advantage of a pre-debinding machining is that it requires less energy than a machining on a harder final part. Moreover, a machining error on a green part with less added value has less impact than a machining error on a final part with high added value.

Moreover, as can be seen in FIGS. 6 and 7, the method described in the present application makes it possible, in welding PIM parts, overcome the constraint imposed by the co-sintering known from the prior art which entails that the junction zone 14 is delimited by all of the initial surfaces 30, 32 in contact with the parts 10, 12 to be assembled (see FIG. 6). Thanks to the solution proposed by the method of the present application, it is the contact surfaces 34, 34′, 36, 38 between the weld bead 16 and the parts to be assembled 10, 12 that constitute the junction zone 14 (see FIG. 7). There are therefore four contact surfaces 34, 34′, 36, 38 where before there were only two, 30, 32. The direct advantage that results therefrom is that the mechanical strength of the junction zone 14 post-welding is improved.

Thus, following the adding of the weld bead 16, the homogenous single-piece assembly forms a final part 1 (see FIG. 5) integrally that comprises two parts 10, 12 and the weld bead 16. The junction zone 14 comprises at least four surfaces 34, 34′, 36, 38 (a first surface 36 belonging to the first part 10, a second surface 38 belonging to the second part 12, third and fourth surfaces 34, 34′ belonging to the weld bead 16): the first surface 36 cooperates with the third surface 34, and the second surface 38 cooperates with the fourth surface 34′ during the sintering step and makes it possible to reinforce the mechanical strength of the final part 1.

Moreover, as mentioned hereinabove, the co-sintering of the surfaces 30, 32 of the green parts 10, 12 in contact is not necessary: as the junction is carried out via co-sintering of the surfaces 36, 38 of the green parts 10, 12 in contact with surfaces 34, 34′ of the weld bead 16, added in a second step in such a way as to hug the shape of the junction zone 14, the contact between the different surfaces 34, 34′, 36, 38 to be welded is satisfactory and does not require preparation upstream of the sintering step.

Following the adding and the possible machining of the weld bead 16, the homogeneous green one-piece assembly is de-bound, then sintered, in such a way as to obtain a homogeneous and dense one-piece assembly, which is a final part, as can be seen in FIGS. 7 and 8.

Thus an illustration of an example of the complete method of production of green assembled parts as described in the present application is, for example with parts made from Inconel 718®:

injection of the parts to be assembled, for example two separate parts 10, 12;

assembly of the parts 10, 12 by the method claimed in the present application, by adding a weld bead 16 made of Inconel 718®;

possible machining reworking in the junction zone 14 if needed;

de-binding according to a conventional protocol defined for Inconel 718®,

sintering according to a conventional method defined for Inconel 718®.

During sintering, the portion of the one-piece assembly that comprises powders of finer granulometry, corresponding to the second green part 12, has finer grains, while the portion of the final part 1 that comprises powders of greater granulometry, corresponding to the first green part 10, has larger grains (see FIG. 8).

As the two green parts 10, 12 are already of different granulometries, the sintered one-piece assembly can then follow a standard and homogeneous heat treatment: the dual microstructure is produced at the sintering step.

The same type of result can be obtained by varying the chemical composition of the powders of each one of the green parts 10, 12 rather than their granulometry, for example by using a superalloy with a nickel base with a variable carbon content. In this type of superalloy, the carbon precipitates in the form of carbide and this precipitated carbon content more or less opposes the enlarging of the grain during sintering.

In particular, by using a first feedstock (a first part 10) comprising a powder with chemistry no. 1 and a second feedstock (a second part 12) comprising a powder with chemistry no. 2. This can, for example, be an alloy of René 77® with a high rate of carbon as a powder with chemistry no. 1 and an alloy of René 77® with a low carbon content as a powder of chemistry no. 2. A sintered one-piece assembly is thus obtained that has a dual structure, thanks to the fact that the carbon content has, on the René 77®, an influence on the enlarging of the grain during sintering.

Various embodiments make it possible to obtain final parts 1 that have different granulometries. For example with powders of Inconel 718® that have a D₉₀ less than 16 μm, 25 μm or 45 μm. It also possible to consider a case wherein the two powders that have a different chemical composition by taking, for example, René 77® containing 660 ppm of carbon or 160 ppm of carbon. These measured values of D₉₀ relate to the granulometry of the powders used in the feedstock that forms each part taken separately.

The parameter D₉₀, represents a point on the distribution curve of the sizes of particles that comprise a part. This particular point indicates what size 90% of the particles of the total volume of the part considered have. For example, if the D₉₀ is 844 nm, then 90% of the particles of the part considered have a diameter less than or equal to 844 nm and 10% therefore have a larger size. This measurement can in particular be obtained via laser diffraction. Conventionally, in order to characterise the granulometry of a part, D₁₀, D₅₀ and D₉₀ are measured. D₁₀ is always smaller than D₅₀ which is smaller than D₉₀. The closer the values are, the more homogeneous the size of the particles of powder is.

The technical lock resides in forming a final part 1 in the green state using two different feedstocks (green parts 10, 12). Indeed, it is important that the two feedstocks have a proportion of filler (proportion of powder/binder) that is similar, which guarantees a volumetric shrinkage that is identical or substantially identical of each of the green parts 10, 12 during sintering.

It is also required that the sintering ranges of the green parts 10, 12 be compatible together.

It must also be ensured that the forming of the green parts 10 and 12 allows for obtaining a sound interface 14 at the junction between the two green parts 10, 12.

An illustration of the complete method of production of green assembled parts as described in the present application is, for example, carried out with parts made of Inconel 718®:

injection of the parts to be assembled, for example two separate parts 10, 12 one of which would be of granulometry A and the other of granulometry B;

assembly of parts 10, 12 by the method claimed in the present application;

possible machining reworking in the junction zone 14 if needed;

de-binding according to a conventional protocol defined for Inconel 718®,

sintering according to a conventional protocol defined for Inconel 718®.

1. Method for welding together at least two parts of green material, referred to as green parts, comprising the following steps:
assembling the at least two green parts at a junction zone of said parts so as to form a green one-piece assembly,
de-binding the green one-piece assembly, and
sintering the one-piece assembly so as to obtain a dense one-piece assembly forming a final part,
wherein the two green parts are each having a different powder composition, so as to produce a final part having at least two parts with different grain sizes.

2. Method according to claim 1, wherein at least two green parts have powder compositions with different granulometries.

3. Method according to claim 2, wherein the green parts comprise powders that have a D₉₀ less than 16 μm, 25 μm or 45 μm.

4. Method according to claim 1, wherein at least two green parts have different powder chemical compositions.

5. Method according to claim 1, wherein it comprises a step of adding a weld bead to the green parts in such a way that the weld bead hugs the shape of the junction zone, and in such a way as to form a homogeneous green one-piece assembly.

6. Method according to claim 5, wherein the weld bead is of a composition similar to that of the green parts.

7. Method according to claim 5, wherein the weld bead and the green parts to be assembled are of identical compositions.

8. Dense one-piece assembly forming a final part, comprising at least two green parts assembled by the method according to claim 1, wherein the at least two green parts have a different composition, in such a way that the final part has at least two parts with a different grain size.

9. Assembly according to claim 8, wherein the at least two green parts have a powder composition with a different granulometry.

10. Assembly according to claim 8, wherein the at least two green parts have a chemical composition.
